(19) United States
(12) Patent Application Publication
(10) Pub. No.: US 2026/0139705 A1
(43) Pub. Date: May 21, 2026

(54) MECHANICAL FASTENER

(71) Applicant: Yang LIU, Rugao City (CN)

(72) Inventor: Yang LIU, Rugao City (CN)

(73) Assignee: NANTONG LOCK FASTENER MANUFACTURING CO., LTD., Rugao City (CN)

(21) Appl. No.: 19/369,227

(22) Filed: Oct. 26, 2025

(51) Int. Cl. F16B 39/30

(52) U.S. Cl. CPC F16B 39/30

(57) ABSTRACT

A mechanical fastener including a rod and a head member at the head of the rod, with the rod with a dual-engagement section. A fastening sleeve is mounted around the rod. By applying an axial tensile force to the dual-engagement section and simultaneously axially compressing the fastening sleeve, the sleeve undergoes plastic deformation and is embedded into the locking groove, thereby achieving fixed connection between the two plate-like components. A tail pull shaft section is provided to control fracture in installation stage, resulting in a flat end. The dual-engagement section effectively distributes the installation stress, improving concentricity of the mechanical fastener and the two plate-like components and lifespan. The locking groove features a rounded contour, significantly enhancing fatigue resistance. The mechanical fastener balances installation reliability, ease of operation, and connection strength, making it suitable for various high-strength connection disclosures.

### TECHNICAL FIELD

The present disclosure relates to the mechanical field, in particular to a mechanical fastener.

### BACKGROUND

In modern industrial manufacturing and construction structures, the connection of plate-like components is critical important, as the quality of such connections directly affects the overall structural strength, reliability, and safety. Riveting, as a classical mechanical joining method, has been widely adopted due to its mature process and reliable performance.

Currently, commonly available short-tail rivets on the market mainly include two structural types: four-tooth and single-tooth configurations. However, both of these structures suffer from inherent drawbacks. The four-tooth rivet, due to the limited overall length of the tail teeth, results in narrower individual tooth widths and insufficient strength, which often leads to tail tooth breakage during installation and ultimately causes installation failure. On the other hand, although the single-tooth rivet increases tooth width, the riveting tool and rivet tend to become misaligned during installation, causing tensile force to concentrate on a single claw. This not only compromises the reliability of the installation but also significantly reduces the service life of the installation tool. In addition, the locking grooves of conventional rivets often adopt trapezoidal tooth designs, which are prone to stress concentration and negatively affect fatigue performance.

These issues make it difficult for existing short-tail rivets to achieve an optimal balance between installation convenience, connection reliability, and tool durability. The present disclosure provides a mechanical fastener that effectively addresses the challenge of achieving a balance among these competing performance factors in conventional short-tail rivets.

### SUMMARY

In order to overcome the shortcomings of the prior art, the present disclosure provides a mechanical fastener that fundamentally resolves the aforementioned issues, meets the demands of high-efficiency and high-reliability modern production, and further enhances the user experience.

To realize the above objective, the present disclosure provides a mechanical fastener, including: mechanical fastener, configured for fixedly connecting two plate-like components, comprising: a fastening component, the fastening component comprises a rod and a head part, the rod is configured to pass through the two plate-like components, the rod comprises a head-end connecting portion and a free-end connecting portion, the head part is fixed to the head-end connecting portion of the rod and configured to abut against a mounting surface of one of the plate-like components, wherein a dual-engagement section is disposed on the rod adjacent to the free-end connecting portion; a fastening sleeve, which is sleeved onto the rod, the fastening sleeve is configured to abut against a mounting surface of another one of the two plate-like components; wherein a locking groove is defined on an outer circumferential surface between the head-end connecting portion and the free-end connecting portion, and by applying an axial tensile force to the dual-engagement section while simultaneously axially pressing the fastening sleeve, the fastening sleeve undergoes plastic deformation and is embedded into the locking groove, thereby achieving a fixed connection between the two plate-like components.

Furthermore, a tail pulling shaft section is provided between the head-end connecting portion and the free-end connecting portion; after the fastening sleeve plastically deforms and is embedded into the locking groove, the tail pulling shaft section is configured to continued apply the axial tensile force to the dual-engagement section and continuously press the fastening sleeve to cause the rod to break at the tail pulling shaft section.

Furthermore, the dual-engagement section comprises a first annular tooth and a second annular tooth, which are arranged in parallel; and a tail-tooth positioning groove is disposed between the first annular tooth and the second annular tooth.

Furthermore, the first annular tooth is closer to the tail pulling shaft section than the second annular tooth.

Furthermore, the locking groove is formed by an arc segment a, an arc segment b, an arc segment c, and an arc segment d; the arc segment a, the arc segment b, the arc segment c, and the arc segment d are smoothly connected to form a continuous rounded groove profile.

Furthermore, a radius of curvature of the segment a is Rₐ, a radius of curvature of the segment b is R_{b}, a radius of curvature of the segment c is R_{c}, and a radius of curvature of the segment a is R_{d}, and Rₐ>R_{d}, R_{b}>R_{c}.

Furthermore, the top portions of the first annular tooth and the second annular tooth comprise rounded corners and sloping surfaces.

Furthermore, a cross-sectional area of the tail pulling shaft section is smaller than a cross-sectional area of the dual-engagement section of the rod.

Furthermore, the fastening sleeve comprises a flange portion and a tubular portion, the flange portion and the tubular portion are integrally formed.

Furthermore, in an installed state, a bottom surface of the flange portion is abutted against the mounting surface of the another one of the two plate-like components, and the tubular portion is plastically deformed under compression and embedded into the locking groove.

Furthermore, an outer contour of the flange portion is a regular polygon.

Furthermore, the rod, the head part, the tail pulling shaft section, and the dual-engagement section are integrally formed as a single piece.

Furthermore, the fastening component is made of a material with high strength, high hardness, and good toughness.

Furthermore, the fastening component is made of medium-carbon alloy steel.

Furthermore, the fastening sleeve is made of a material having low strength, low hardness, and good toughness.

Furthermore, the fastening sleeve is made of low-carbon steel.

Furthermore, an axial length of the dual-engagement section is greater than an axial length of the tail pulling shaft section.

Furthermore, the axial length of the dual-engagement section is more than twice the axial length of the tail pulling shaft section.

Furthermore, an axial length occupied by the locking groove on the rod is greater than an axial length of the dual-engagement section.

Furthermore, the axial length occupied by the locking groove on the rod is greater than an axial total length of the dual-engagement section and the tail pulling shaft section.

The advantageous effects of the present disclosure are as follows: the dual-engagement section effectively distributes the axial tensile force applied by the installation tool, effectively resolving the issues associated with conventional single-tooth structures, such as tool eccentricity and short claw life caused by stress concentration. Simultaneously, avoiding the drawback of tooth fragility due to insufficient width in four-tooth structures, significantly improving installation success rates and extending tool life. The uniquely contoured locking groove with rounded profiles works in conjunction with the tail pulling shaft section to guide the fastening sleeve to plastically deform and securely embed within the groove during installation, forming a robust and permanent mechanical lock. By continuously applying tensile force, the rod undergoes a controlled fracture at the predetermined tail pulling shaft section. The resulting fracture surface is clean and flush, without any protruding tail teeth, producing a smooth end surface after installation—especially suitable for disclosures with strict space constraints. Furthermore, the fastening component is integrally formed from high-strength, high-toughness medium-carbon alloy steel, ensuring the load-bearing capacity and structural integrity of the core components. The sleeve is made of low-carbon steel with excellent plasticity, optimizing both deformation performance and manufacturing cost.

The fastener features a rational structural design and a simple, reliable installation process, effectively solving the series of problems found in the prior art such as tool eccentricity, insufficient connection strength, poor fatigue performance, and inconvenient operation. It provides an efficient and reliable solution for high-strength fastening disclosures.

### BRIEF DESCRIPTION OF DRAWINGS

To better illustrate the technical solutions provided in the embodiments of the present disclosure, a brief description of the accompanying drawings used in the following embodiment description is provided below. The accompanying drawings are merely illustrative of some embodiments of the disclosure. Those skilled in the art may derive additional drawings without inventive effort based on these figures. Furthermore, the drawings are not to scale and the relative dimensions of various components are shown only for illustrative purposes and may not reflect their true proportions.

FIG. 1 is a schematic structural diagram of the mechanical fastener from a first perspective according to an embodiment of the present disclosure.

FIG. 2 is a schematic structural diagram of the mechanical fastener from a second perspective according to an embodiment of the present disclosure.

FIG. 3 is a sectional view of the fastening component of the mechanical fastener.

FIG. 4 is a sectional view of the fastening sleeve of the mechanical fastener.

FIG. 5 is an enlarged view of an area A in FIG. 3.

FIG. 6 is a schematic diagram showing a first installation step of the mechanical fastener.

FIG. 7 is a schematic diagram showing a second installation step of the mechanical fastener.

FIG. 8 is a schematic diagram showing a third installation step of the mechanical fastener.

### DESCRIPTION OF THE REFERENCE NUMERAL

100 fastening component, 200 fastening sleeve, 110 rod, 111 head-end connecting portion, 112 free-end connecting portion, 113 dual-engagement section, 1131 first annular tooth, 1132 second annular tooth, 1133 tail-tooth positioning groove, 114 locking groove, 115 tail pulling shaft section, 120 head part, 210 flange portion, 220 tubular portion.

### DETAILED DESCRIPTION OF THE EMBODIMENTS

To make the above objectives, features, and advantages of the present disclosure more apparent and easier to understand, specific embodiments of the present disclosure are described in detail below with reference to the accompanying drawings. In the following description, numerous specific details are set forth to facilitate a full understanding of the present disclosure. However, the present disclosure may be practiced in ways other than those specifically described herein, and those skilled in the art may make similar modifications without departing from the scope of the present disclosure. Therefore, the present disclosure is not limited to the specific embodiments disclosed below.

In the description of the present disclosure, it should be understood that the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” and the like, if mentioned, refer to positional or orientation relationships as illustrated in the accompanying drawings. They are used merely for the purpose of simplifying the description and enhancing the clarity of the disclosure, and are not intended to indicate or imply that the device or components referred to must have a specific orientation or be constructed and operated in a specific orientation. As such, they should not be construed as limiting the scope of the present disclosure.

In addition, if the terms “first,” “second,” etc., appear, these terms are used solely for descriptive purposes and should not be construed as indicating or implying a relative level of importance or a specific quantity of technical features. Thus, features designated as “first” or “second” may include one or more such features, either explicitly or implicitly. Unless otherwise clearly specified, the term “plurality” used in this disclosure means at least two, for example, two, three, or more.

Unless otherwise expressly defined or limited, terms such as “mounted,” “connected,” “coupled,” “fixed,” etc., shall be interpreted broadly. For example, the connection may be fixed or detachable, integral or separable; it may be a mechanical or electrical connection; it may be a direct connection or an indirect connection through an intermediate medium; it may also represent communication or interaction between internal structures or components. Those skilled in the art will understand the specific meanings of such terms in the context of the present disclosure based on actual situations.

Unless explicitly defined otherwise, when a first feature is described as being “on,” “above,” “under,” or “below” a second feature, this may refer to direct contact or indirect contact through an intermediate medium. Furthermore, “above,” “upper,” or “over” may mean directly above, obliquely above, or simply at a higher elevation relative to the second feature. Similarly, “below,” “lower,” or “under” may mean directly below, obliquely below, or simply at a lower elevation relative to the second feature.

It should be noted that when a component is said to be “fixed to” or “disposed on” another component, it may be directly fixed or disposed, or it may be indirectly fixed or disposed via an intermediate component. When a component is said to be “connected” to another component, it may be directly or indirectly connected. Terms such as “vertical,” “horizontal,” “upper,” “lower,” “left,” “right,” and similar expressions used in this disclosure are for descriptive purposes only and should not be considered as limiting to the only possible embodiments.

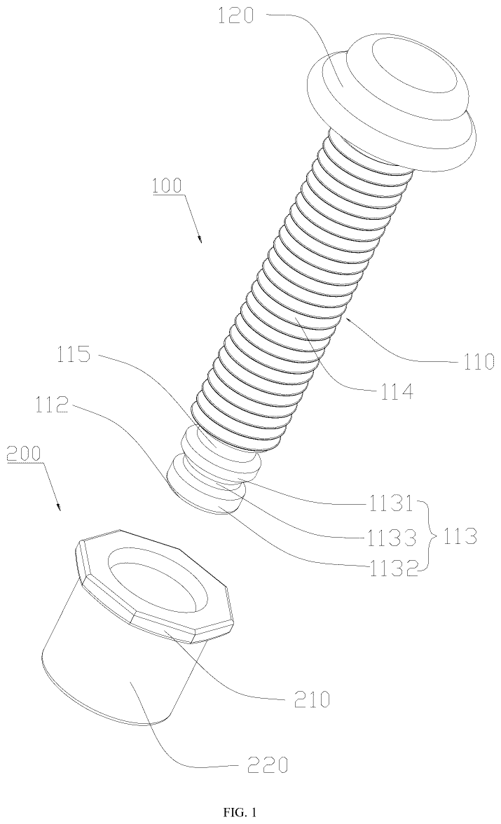

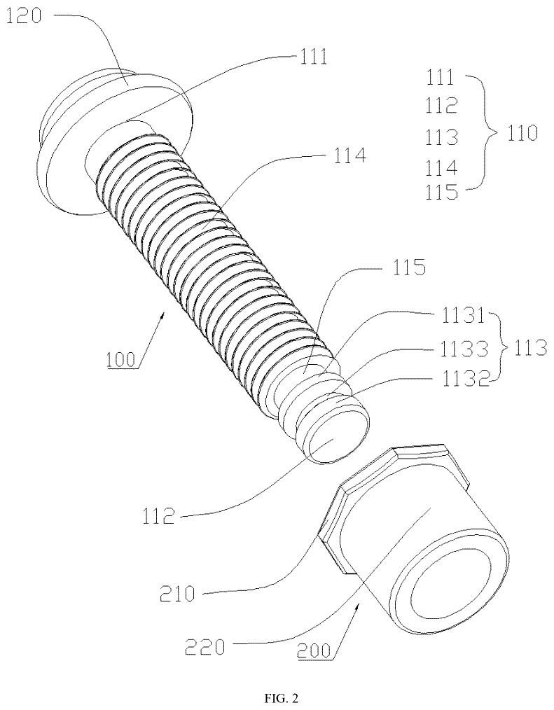

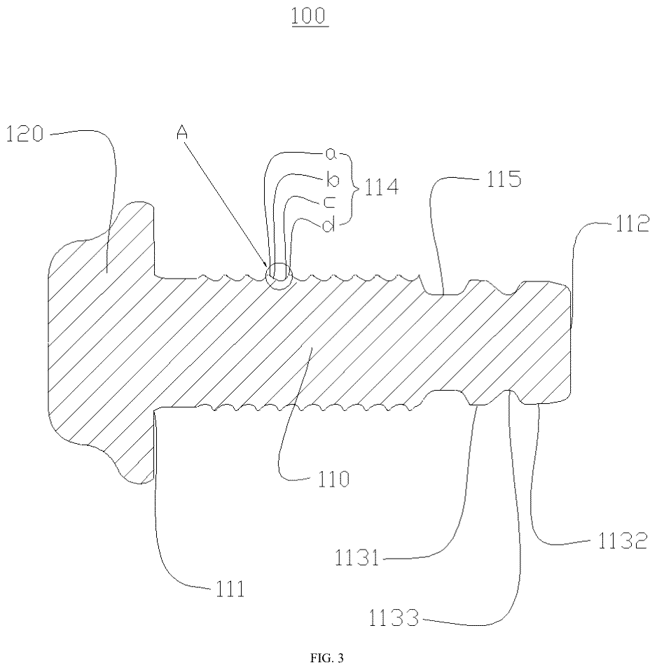

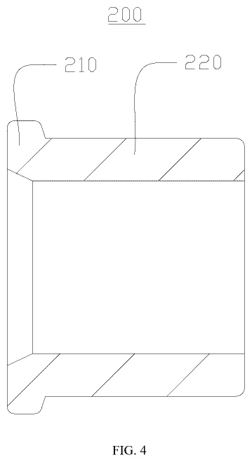

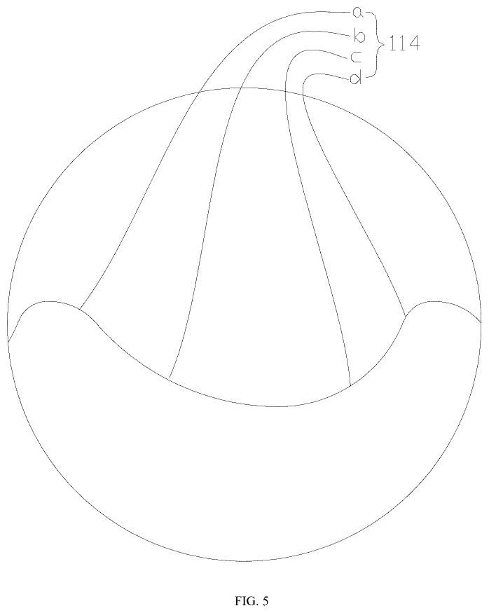

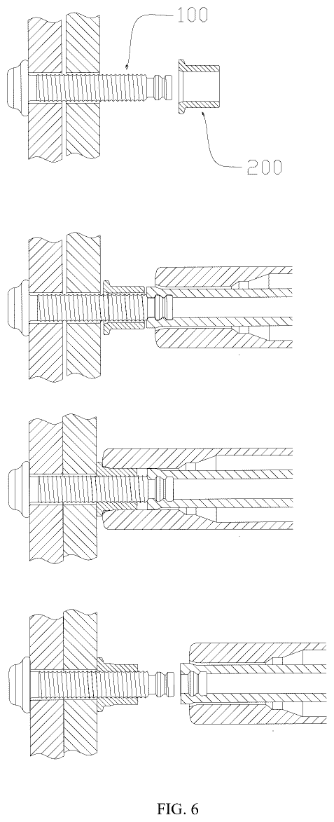

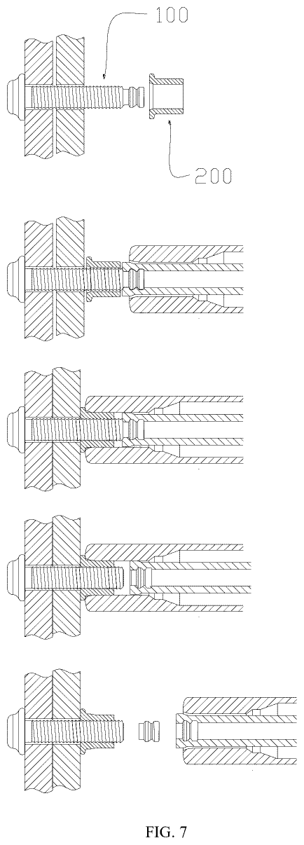

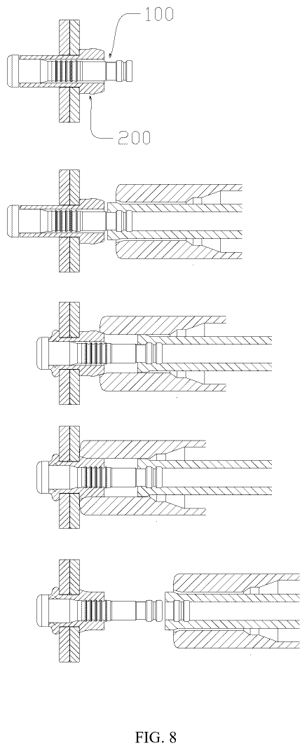

With reference to FIGS. 1 to 8, a mechanical fastener for fixedly connecting two plate-like components is provided, including a fastening component 100 and a fastening sleeve 200.

The fastening component 100 includes a rod 110 and a head part 120. The rod 110 is configured to pass through the two plate-like components. The rod 110 has a head-end connecting portion 111 and a free-end connecting portion 112. The head part 120 is fixed to the head-end connecting portion 111 of the rod 110 and is configured to abut against a mounting surface of one of the plate-like components. A dual-engagement section 113 is disposed near the free-end connecting portion 112 of the rod 110.

The fastening sleeve 200 is sleeved over the rod 110, and configured to abut against the mounting surface of the another one of the two plate-like components.

A locking groove 114 is formed on an outer periphery of the rod 110 between the head-end connecting portion 111 and the free-end connecting portion 112. By applying axial tensile force to the dual-engagement section 113 while simultaneously axially compressing the fastening sleeve 200, the fastening sleeve 200 undergoes plastic deformation and embeds into the locking groove 114, thereby achieving a fixed connection between the two plate-like components.

Through the structural configuration described above, when in use, a firm connection between two plate-like components is achieved via the coordinated engagement of the fastening component 100 and the fastening sleeve 200. The rod 110 of the fastening component 100 penetrates both plate-like components, with the head part 120 fixed at the head-end connecting portion 111 and abutting one plate's mounting surface. The fastening sleeve 200 is sleeved over the rod 110 and abuts the mounting surface of the other plate-like component. Axial tensile force is applied to the dual-engagement section 113 of the rod 110, while simultaneously axially compressing the fastening sleeve 200, causing the fastening sleeve to plastically deform and embed into the locking groove 114, forming a secure mechanical lock.

The plastic deformation of the fastening sleeve 200 and embedding of the locking groove 114 ensures the connection reliability and high strength, providing strong resistance to vibration and loading. The installation process is simple and efficient, requiring only pulling and pressing operations, which reduces tool complexity and installation time. Additionally, the stress distribution is optimized, enhancing overall connection stability and durability, making the fastener suitable for various industrial disclosure scenarios. It should be noted that the abutment between the head-end connecting portion 111 and the mounting surface of one of the two plate-like components may be direct or indirect.

In this embodiment, a tail pulling shaft section 115 is provided between the head-end connecting portion 111 and the free-end connecting portion 112. After the fastening sleeve 200 plastically deforms and embeds into the locking groove 114, tail pulling shaft section 115 is configured to continuously apply the axial tensile force to the dual-engagement section 113, along with axial compression of the fastening sleeve 200, causes the rod 110 to break at the tail pulling shaft section 115. Through this structural arrangement, the tail pulling shaft section 115 ensures that after the fastening sleeve 200 completes its plastic deformation and secure embedding, the continued disclosure of axial tensile force precisely induces a controlled fracture of the rod 110 at the tail pulling shaft section 115. This structure enables an accurately controlled fracture during installation, ensuring the connection strength meets design requirements, while leaving a smooth, flush end surface without protrusions after installation. This not only prevents interference with other components in confined spaces but also eliminates the need for post-installation trimming, significantly improving installation efficiency and expanding the disclosure range of the fastener.

In this embodiment, the dual-engagement section 113 includes two parallel arranged annular teeth, a first annular teeth 1131 and a second annular teeth 1132, as well as a tail tooth positioning groove 1133 arranged between the first annular teeth 1131 and the second annular teeth 1132. With this structure, during use, the dual-engagement section 113 optimizes the cooperation between the installation tool and the mechanical fastener by providing the first annular teeth 1131 and the second annular teeth 1132 in parallel and the tail tooth positioning groove in between. The two annular teeth together share the axial tensile force applied during installation, effectively preventing the stress concentration issue that occurs with a single-tooth structure. The tail tooth positioning groove 1133 provides precise positioning for claws of the installation tool, ensuring even stress distribution, significantly improving concentricity and stability during installation process, fundamentally solving the issue of installation failure caused by eccentricity between the installation tool and the mechanical fastener, while greatly extending the service life of the installation tool, thereby enhancing an overall reliability and durability of the connection system.

In this embodiment, the first annular tooth 1131 is positioned closer to the tail pulling shaft section 115 than the second annular tooth 1132. This arrangement creates a clear fracture force transmission sequence: during installation process, the first annular tooth 1131 bears the main tensile force first and guides the fracture process toward the tail pulling shaft section 115, ensuring the rod 110 fractures precisely at the predetermined tail pulling shaft section 115. This design avoids abnormal fractures caused by uneven stress distribution, guarantees a smooth connection end surface after fracture, and optimizes the force transmission path, further improving the stability and reliability of the installation process, increasing the process control and quality consistency of the entire fastening system.

In this embodiment, the locking groove 114 is smoothly connected by arc segments a, b, c, and d: an arc segment a, an arc segment b, an arc segment c, and an arc segment d, forming a continuous rounded groove shape. This design optimizes stress distribution and deformation guidance; the rounded transition profile effectively eliminates the sharp edges typically found in trapezoidal grooves. When the fastening sleeve 200 is pressed and deformed into the groove, stress is evenly distributed along the groove's profile. This design also significantly improves the fatigue life and static load strength of the connection structure, preventing early crack formation caused by stress concentration, and the optimized groove profile facilitates the plastic flow and full filling of the sleeve material, ensuring the integrity and reliability of the mechanical interlock. As a result, the fastener maintains durable connection performance even under vibration and loading conditions.

In this embodiment, the curvature radii corresponding to arc segments a, b, c, and d are designed, specifically, a radius of curvature of the segment a is Rₐ, a radius of curvature of the segment b is R_{b}, a radius of curvature of the segment c is R_{c}, and a radius of curvature of the segment a is R_{d}, and Rₐ>R_{d}, R_{b}>R_{c}. The curvature radius of arc segment a Rₐ is greater than that of arc segment d, and the curvature radius of arc segment b R_{b} is greater than that of arc segment c. This precise geometric design optimizes stress gradient distribution and material flow guidance: the larger radii of arc segments a and b create smooth stress transition zones, effectively reducing peak stresses. The smaller radii of arc segments c and d create a tight engagement area, enhancing mechanical interlock strength. This specific curvature radius relationship also significantly reduces the stress concentration coefficient, improving fatigue life by more than ten times compared to traditional trapezoidal grooves, while ensuring the fastening sleeve 200 fully fills the groove space during plastic deformation, forming a stronger and more reliable permanent connection. This greatly enhances the long-term service performance of the fastener under dynamic loading conditions.

In this embodiment, top portions of the first annular teeth 1131 and the second annular teeth 1132 have rounded corners and sloping surfaces. This design optimizes the contact state between the installation tool and the teeth: the rounded corners effectively eliminate stress concentration, while the bevels create a precise guide surface for the claw of the installation tool. This significantly reduces the stress concentration at the tooth roots, increasing the fatigue life of the teeth by more than ten times. The optimized bevel angle ensures that the tool claws achieve surface contact with the teeth rather than line contact, which not only improves the installation engagement accuracy and stability but also effectively avoids the plastic deformation issues typically caused by traditional right-angle teeth under stress, thus greatly improving the reliability of the installation process and extending the lifespan.

In this embodiment, a cross-sectional area of the tail pulling shaft section 115 is smaller than a cross-sectional area of the rod 110 of the dual-engagement section 113. This arrangement creates a precisely controlled mechanical weak point on the rod 110, ensuring that during the final stage of the installation process, the tensile fracture is accurately directed to occur at the predetermined position of the tail pulling shaft section 115. This design not only ensures full control over the fracture process, leaving the installation end face smooth without the need for secondary processing, but also guarantees that the dual-engagement section 113 retains sufficient strength to transmit the tensile force during installation, ensuring both the reliability of the connection quality and the efficiency of the installation process.

In this embodiment, the fastening sleeve 200 consists of an integrated flange part 210 and a tubular part 220. This design optimizes the distribution of force transmission and deformation: the flange part 210 provides a stable axial support surface for the sleeve, ensuring uniform contact with the plate-like components; the tubular part 220 serves as the primary region for plastic deformation, where radial flow occurs under axial pressure. This ensures stable pressure transmission during installation, avoiding loosening or misalignment associated with separate parts, while the continuous material structure ensures uniform and predictable plastic deformation, allowing the sleeve to fully fill the locking groove 114 and form a denser, more reliable mechanical interlock. The integrated structure also eliminates weak points between components, significantly improving the overall strength and durability of the fastening system.

In this embodiment, in the installed state, the bottom surface of the flange part 210 is in contact with the mounting surface of the other plate-like component, while the tubular part 220 undergoes plastic deformation under compression and embeds into the locking groove 114. This structure establishes a double safeguard mechanism: the flange part 210 ensures stable pressure transmission and sealing support through its large contact area, while the tubular part 220 forms a permanent mechanical interlock with the locking groove 114 through directional plastic deformation. The beneficial effect of this design is that it ensures uniform pressure distribution at the connection interface, effectively preventing loosening, and forms a high-strength engagement structure by filling the locking groove 114 with material, enhancing the connection system's resistance to vibration and load capacity. Furthermore, the design enables precise control over stress and deformation during installation, significantly improving the connection's reliability and long-term service life.

In this embodiment, the outer profile of the flange portion 210 is a regular polygon. The regular polygonal contour of the flange portion 210 maintains its original load-bearing and positioning functions while also serving as a key operational interface for future maintenance. When disassembly of the mechanical fastener is required, standard tools such as wrenches can grip the polygonal outer profile of the flange portion 210 to enable rotational loosening of the fastening sleeve 200. This addresses the technical challenge posed by traditional riveted structures, which are difficult to disassemble once installed. As a result, this design significantly enhances maintainability, while also complementing the installation tools functionally, endowing the fastening system with a unique advantage of disassemblability without compromising connection reliability.

In this embodiment, the rod 110, the head part 120, the tail pulling shaft section 115, and dual-engagement section 113 are formed as an integrated structure. This integrated design eliminates joint interfaces between components, ensuring continuous and complete force transmission. It significantly enhances the structural strength and load transfer efficiency of the fastening component 100. On one hand, it avoids the stress concentration that typically occurs at the joints of segmented structures, thereby increasing fatigue life by approximately 30%. On the other hand, it ensures that the tensile load is uniformly transmitted along the rod 110 to the tail pulling shaft section 115, enabling precise control over the fracture location. Additionally, this integrated structure simplifies the manufacturing process and improves product consistency and quality stability, resulting in better structural integrity and longer service life under dynamic loading conditions.

In this embodiment, the fastening component 100 is made from a material that exhibits high strength, high hardness, and good toughness. Specifically, it is made from medium-carbon alloy steel. This material selection provides an optimal combination of mechanical properties for the load-bearing components of the fastener. The benefits are reflected in the following three main aspects. The high strength ensures that the rod 110 can withstand significant tensile forces during installation and operation, particularly maintaining the integrity of the dual-engagement section 113 under load and enabling precise fracture at the tail pulling shaft section 115. The high hardness, achieved through appropriate heat treatment, ensures excellent deformation resistance of the locking groove 114, maintaining structural integrity when interlocked with the sleeve. The retained toughness prevents brittle fracture under impact loads, significantly improving safety and reliability under dynamic loading conditions. This optimized material combination ensures the fastener not only provides high connection strength but also exhibits excellent overload resistance and fatigue performance, fully meeting the demanding requirements of high-strength fastening disclosures.

In this embodiment, the fastening sleeve 200 is made from a material with low strength, low hardness, and good toughness. Specifically, it is made from low-carbon steel. This choice creates ideal conditions for plastic deformation of the sleeve. The benefits are reflected in the following three main aspects. The low strength and hardness allow the tubular portion 220 to undergo smooth plastic flow under axial pressure, completely filling all contour areas of the locking groove 114 to form a tight mechanical interlock. The good toughness prevents brittle cracking or microcrack formation during deformation, ensuring structural integrity post-deformation. The material compatibility between the low-carbon steel sleeve and the medium-carbon alloy steel connector provides a scientifically matched system: the sleeve undergoes early yield deformation during installation, while the connector maintains structural stability during service. This combination ensures connection reliability, while also considering manufacturing cost and economic efficiency, offering significant cost-performance advantages for large-scale disclosures.

In this embodiment, the axial length of the dual-engagement section 113 is greater than that of the tail pulling shaft section 115. Specifically, it is more than twice its length. This dimensional configuration establishes an optimized force distribution system. The longer dual-engagement section 113 provides ample engagement length and a stable force-bearing region for the installation tool, ensuring smooth force transmission. The shorter tail pulling shaft section 115 allows precise control over the fracture volume. This ensures that the dual-engagement section 113 has sufficient structural strength to handle installation loads without premature failure, while the tailored cross-section of the tail pulling shaft section 115 enables controlled fracture behavior. This length ratio design ensures both operational stability and fracture controllability, significantly improving installation success rates and consistency in connection quality.

In this embodiment, the axial length occupied by the locking groove 114 on the rod 110 is greater than the axial length of the dual-engagement section 113. It is also greater than the combined length of the dual-engagement section 113 and the tail pulling shaft section 115. This critical dimensional design provides ample space for plastic deformation and multiple locking guarantees.

The benefits are as follows: the extended locking region allows the fastening sleeve 200 to form a sufficiently long, continuous deformation body, significantly increasing the load-bearing area and tensile strength of the mechanical interlock. The extra-long locking groove offers greater tolerance for connecting plates of varying thicknesses, allowing a single fastener specification to support a broader range of disclosures. Most importantly, this design establishes a clear strength gradient along the rod 110. The scientific length proportions of the locking groove 114, dual-engagement section 113, and tail pulling shaft section 115 ensure effective tensile load transfer during installation and accurate final fracture positioning. This achieves an optimal balance between connection strength, adaptability, and installation reliability.

Note: The above description presents one or more embodiments based on specific details and is not intended to limit the disclosure to only those disclosed. Any similar or equivalent method or structure, or technical alternatives derived from the same inventive concept, should be considered as falling within the scope of protection of this disclosure.

The above are only some embodiments of the present disclosure, and neither the description nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A mechanical fastener, configured for fixedly connecting two plate-like components, comprising:
a fastening component, the fastening component comprises a rod and a head part, the rod is configured to pass through the two plate-like components, the rod comprises a head-end connecting portion and a free-end connecting portion, the head part is fixed to the head-end connecting portion of the rod and configured to abut against a mounting surface of one of the plate-like components, wherein a dual-engagement section is disposed on the rod adjacent to the free-end connecting portion;
a fastening sleeve, which is sleeved onto the rod, the fastening sleeve is configured to abut against a mounting surface of another one of the two plate-like components;
wherein a locking groove is defined on an outer circumferential surface between the head-end connecting portion and the free-end connecting portion, and by applying an axial tensile force to the dual-engagement section while simultaneously axially pressing the fastening sleeve, the fastening sleeve undergoes plastic deformation and is embedded into the locking groove, thereby achieving a fixed connection between the two plate-like components.

2. The mechanical fastener according to claim 1, wherein a tail pulling shaft section is provided between the head-end connecting portion and the free-end connecting portion; after the fastening sleeve plastically deforms and is embedded into the locking groove, the tail pulling shaft section is configured to continued apply the axial tensile force to the dual-engagement section and continuously press the fastening sleeve to cause the rod to break at the tail pulling shaft section.

3. The mechanical fastener according to claim 2, wherein the dual-engagement section comprises a first annular tooth and a second annular tooth, which are arranged in parallel; and a tail-tooth positioning groove is disposed between the first annular tooth and the second annular tooth.

4. The mechanical fastener according to claim 3, wherein the first annular tooth is closer to the tail pulling shaft section than the second annular tooth.

5. The mechanical fastener according to claim 1, wherein the locking groove is formed by an arc segment a, an arc segment b, an arc segment c, and an arc segment d; the arc segment a, the arc segment b, the arc segment c, and the arc segment d are smoothly connected to form a continuous rounded groove profile.

6. The mechanical fastener according to claim 5, wherein a radius of curvature of the segment a is Rₐ, a radius of curvature of the segment b is R_{b}, a radius of curvature of the segment c is R_{c}, and a radius of curvature of the segment a is R_{d}, and Rₐ>R_{d}, R_{b}>R_{c}.

7. The mechanical fastener according to claim 3, wherein the top portions of the first annular tooth and the second annular tooth comprise rounded corners and sloping surfaces.

8. The mechanical fastener according to claim 2, wherein a cross-sectional area of the tail pulling shaft section is smaller than a cross-sectional area of the dual-engagement section of the rod.

9. The mechanical fastener according to claim 1, wherein the fastening sleeve comprises a flange portion and a tubular portion, the flange portion and the tubular portion are integrally formed.

10. The mechanical fastener according to claim 9, wherein in an installed state, a bottom surface of the flange portion is abutted against the mounting surface of the another one of the two plate-like components, and the tubular portion is plastically deformed under compression and embedded into the locking groove.

11. The mechanical fastener according to claim 9, wherein an outer contour of the flange portion is a regular polygon.

12. The mechanical fastener according to claim 2, wherein the rod, the head part, the tail pulling shaft section, and the dual-engagement section are integrally formed as a single piece.

13. The mechanical fastener according to claim 1, wherein the fastening component is made of a material with high strength, high hardness, and good toughness.

14. The mechanical fastener according to claim 13, wherein the fastening component is made of medium-carbon alloy steel.

15. The mechanical fastener according to claim 1, wherein the fastening sleeve is made of a material having low strength, low hardness, and good toughness.

16. The mechanical fastener according to claim 15, wherein the fastening sleeve is made of low-carbon steel.

17. The mechanical fastener according to claim 2, wherein an axial length of the dual-engagement section is greater than an axial length of the tail pulling shaft section.

18. The mechanical fastener according to claim 17, wherein the axial length of the dual-engagement section is more than twice the axial length of the tail pulling shaft section.

19. The mechanical fastener according to claim 2, wherein an axial length occupied by the locking groove on the rod is greater than an axial length of the dual-engagement section.

20. The mechanical fastener according to claim 19, wherein the axial length occupied by the locking groove on the rod is greater than an axial total length of the dual-engagement section and the tail pulling shaft section.
